(19) United States
(12) Patent Application Publication
(10) Pub. No.: US 2006/0291715 A1
(43) Pub. Date: Dec. 28, 2006

(54) Machine vision system and method

(75) Inventors: Richard Evans, Rathmines (IE); Iain Lennox, Wicklow (IE); James Mahon, Glasnevin (IE)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: MV RESEARCH LIMITED

(21) Appl. No.: 11/165,814

(22) Filed: Jun. 24, 2005

(51) Int. Cl. G06K 9/00

(52) U.S. Cl. 382/150

(57) ABSTRACT

Solder fillets are inspected post-reflow by illuminating firstly from one side only along a dimension through a row of components. Only pixels arising from light received normal to the joints on that side are analysed. There is then illumination from the opposite side and corresponding image analysis normal to the right side fillets only. This avoids noise arising from reflections from a fillet across to the opposite fillet of an adjacent component.

The invention relates to machine vision inspection of bodies in close proximity. An example is post-reflow quality inspection of electronic circuit boards.

An important function of SMT post reflow quality control is the ability to detect solder defects such as insufficient solder volume or lifted leads (where the solder does not make a joint with a lead). AOI inspection of printed circuit boards works by using a lighting arrangement to illuminate a board and then analysing the images of specular reflections from solder surfaces.

Existing systems analyse the images of solder regions under illumination from light rings at different elevations. This provides an indication of the surface normal slope of the solder surface at different points. Under many circumstances a good solder joint is indicated by steep solder at the interface with a lead. A steep slope is detected by the absence of a bright reflection under such a lighting arrangement. However certain geometries of solder can result in “ghost images” due to secondary reflections. This can result in less accurate defect detection by the system. A secondary reflection occurs when a beam of light from a lighting head is reflected twice, instead of once, on its way to the camera.

As can be seen in Fig. A (which shows a cross section through two soldered connectors in a row), a region of steep solder will typically produce a dark region when lit by a lighting ring (indicating a good joint) whereas a shallow solder will produce a bright region (indicating a lifted lead). Here the beams of light from the lighting ring are reflected from shallow solder up into the camera lens.

The situation is complicated by secondary reflections where two closely spaced steep solder joints face one another. Examples where this can happen include side fillets on a row of pins of a connector, or where chip components are arranged head-to-toe in rows. A cross section through a row of connectors is shown in Fig. B.

This invention addresses this problem.

### SUMMARY OF INVENTION

According to the invention, there is provided a method of inspecting bodies in proximity to each other along a dimension, the method comprising the steps of:
illuminating the bodies with light having a directional component in only one direction along said dimension and capturing a first image;
illuminating the bodies with light having a directional component in only the opposite direction along said dimension and capturing a second image; and
processing the first and second images to analyse the bodies.

In one embodiment, the image processing disregards light normal or close to normal above sides of bodies facing away from the illumination direction.

In another embodiment, the illumination is provided by an illumination head having a plurality of light sources arranged in an array, and a subset of the light sources is activated for each illumination.

In a further embodiment, the dimension is along a row of bodies in close proximity.

In one embodiment, the bodies have sloped sides, and the sides are inspected.

In another embodiment, the bodies are solder joints.

In a further embodiment, the slopes are generally concave.

In one embodiment, the first and second images are processed by masking non-relevant pixels according to stored location data of the bodies.

In another embodiment, the images are combined with reference to a colour look-up table.

In another aspect, the invention provides an inspection method comprising an illuminator, a camera, an image processor and a controller for controlling the system to perform an inspection method as defined above.

### DETAILED DESCRIPTION OF THE INVENTION

The invention will be more clearly understood from the following description of some embodiments thereof, given by way of example only with reference to the accompanying drawings in which:

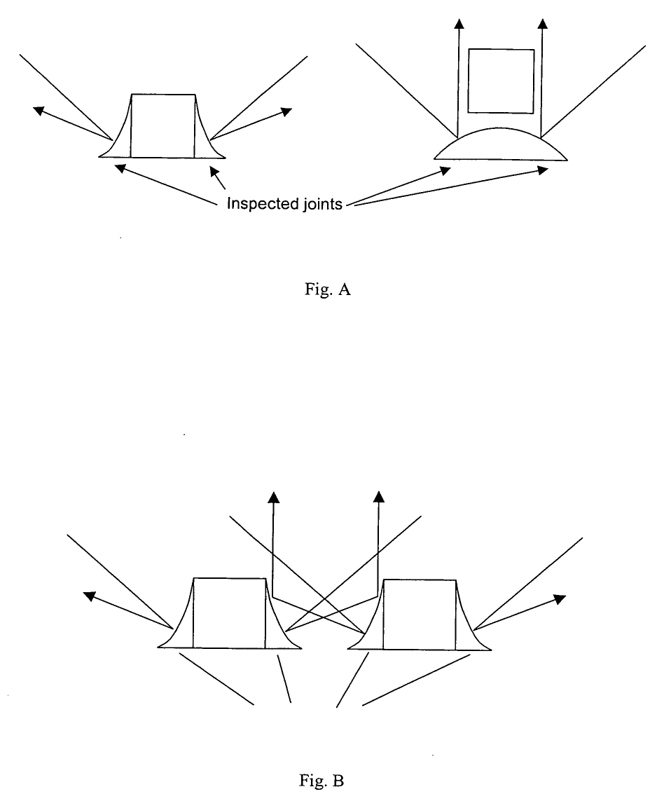

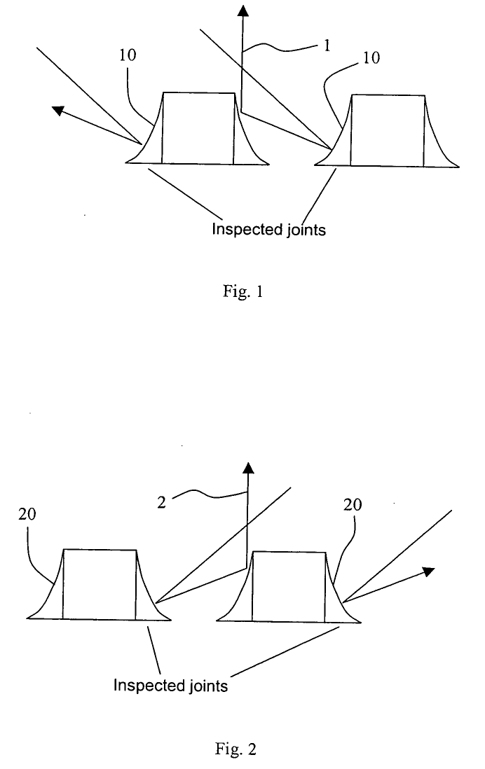

FIGS. 1 and 2 are diagrammatic elevational views of illumination schemes for a system of the invention.

Referring to FIGS. 1 and 2 a machine vision system comprises an illumination head such as that described in EP1455179. This head is controlled so that there is illumination from one side or the other as viewed in elevation as shown in FIGS. 1 and 2. The direction across the elevational view is the main dimension for illumination and image analysis purposes. Only pixels normal to the regions of interest are analysed: above left-side fillets for FIG. 1 and above right-side fillets for FIG. 2.

When there is illumination from the left side as viewed in these drawings there will be a particular pattern for good-quality inspected joints 10. Even though there may be some secondary reflections as shown by the arrow 1, these reflections do not affect the image processing as there is no light captured in a direction normal to the left-side joints. Likewise, for right-side illumination only, as shown in FIG. 2 a secondary reflection 2 does not affect the inspection of the right-side joints 20. In the above, the left-side illumination does not involve any illumination having a component from the opposite side (right side) of this dimension. The opposite is true for right-side illumination. The illumination head is controlled to activate different quadrants or, more generally, sectors. The camera is controlled to acquire a separate image for each illumination. In each image only the pixels arising from light normal to the relevant side are analysed.

If the level of granularity is at the quadrant level, then the choice of which quadrant to use depends on how indirect is the light incident on the surface. If a solder surface is facing northeast, the north quadrant will be 45 degrees away from the ideal angle and so will the east quadrant. The south and west quadrants will each be at an angle of 135 degrees. There may be a threshold of, for example, 60°. Thus as 45° is less than 60° the north and east quadrants will be combined into a single image for processing. By setting the threshold to 45° there can be one quadrant on. If set to 120° there will always be three quadrants on.

One approach to combining source images is by “maxing” them together to generate a new image. Each pixel in the new image is given an intensity equal to the brightest pixel among all of the corresponding pixels in the different source images. The resulting image is then thresholded so that each pixel is classified as bright if its intensity is above the grey scale threhold, and dark otherwise. The percentage of dark pixels is then calculated for each side fillet and each side fillet is classified as good if the percentage of dark pixels is above the coverage threshold, bad otherwise.

The two side fillet results are then combined. The system may OR the results together so that if either side fillet passes, the check passes. The system may AND the results so that both must pass for the check to pass. The system could alternatively use “side fillet averaging” so that the two boxes are treated as a single larger box.

The system may alternatively mask the area based on knowledge of the position and size of the pad. If a side fillet box falls outside the pad region then only the pixels that are within the pad region are masked and hence used to generate a good/bad decision for that side fillet. If the number of masked pixels falls to zero then the decision is based only on the other side fillet. If both side fillet boxes contain zero masked pixels then the side fillet does not generate a decision. The joint will then be inspected as if the side fillet check was switched off.

In another embodiment a color look up table (LUT) is used to combine a number of different images into a single image. The resulting image contains pixels whose intensity depends on how close a match the color of the input pixel is to a set of desired colors. The desired colors will have previously been trained into the LUT by an application engineer using a color picker. The user trains the color picker by selecting groups of pixels from an image of a board (repeatedly if needs be). The color of each pixel is defined by the combined intensities of red, green and blue pixels i.e. the corresponding pixels in 3 different image planes. The system can take up to 8 images, so the ability to vary which images are interpreted as red, green and blue would be important. The technique could in principle be extended to use more than 3 image planes simultaneously. A pixel which is similar to the colors trained in the LUT will be darker than a pixel which is less similar, so the resulting image can be thresholded. The user would be able to create new LUTs with the color picker which would each be given a unique name by the user.

When programming a side fillet algorithm in the algorithm editor, the user would be able to choose a “color picker” instead of a specific set of image planes (e.g. Angle1 and Angle2). Then a new field would appear in the editor, which would contain a list of names of all available LUTs for selection. A possible application of this technique is to eliminate secondary reflections. On some components these can appear as a pink color rather than a bright red. The color picker could have been trained so that pink, black and dark green are all associated with a good joint.

The method finds particular application for inspection of rows of adjacent leads or where chips or other components face each other in close proximity.

The invention is not limited to the embodiments described but may be varied in construction and detail.

What is claimed is:

1. A method of inspecting bodies in proximity to each other along a dimension, the method comprising the steps of:
illuminating the bodies with light having a directional component in only one direction along said dimension and capturing a first image;
illuminating the bodies with light having a directional component in only the opposite direction along said dimension and capturing a second image; and
processing the first and second images to analyse the bodies.

2. A method as claimed in claim 2, wherein the image processing disregards light normal or close to normal above sides of bodies facing away from the illumination direction.

3. A method as claimed in claims 1, wherein the illumination is provided by an illumination head having a plurality of light sources arranged in an array, and a subset of the light sources is activated for each illumination.

4. A method as claimed in claim 1, wherein the dimension is along a row of bodies in close proximity.

5. A method as claimed in claim 1, wherein the bodies have sloped sides, and the sides are inspected.

6. A method as claimed in claim 5, wherein the bodies are solder joints.

7. A method as claimed in claims 5, wherein the slopes are generally concave.

8. A method as claimed in claim 1, wherein the first and second images are processed by masking non-relevant pixels according to stored location data of the bodies.

9. A method as claimed in claim 1, wherein the images are combined with reference to a colour look-up table.

10. (canceled)

11. An inspection method comprising an illuminator, a camera, an image processor and a controller for controlling the system to perform an inspection method comprising:
illuminating the bodies with light having a directional component in only one direction along said dimension and capturing a first image;
illuminating the bodies with light having a directional component in only the opposite direction along said dimension and capturing a second image; and processing the first and second images to analyse the bodies.
